(19) United States
(12) Patent Application Publication
(10) Pub. No.: US 2003/0027105 A1
(43) Pub. Date: Feb. 6, 2003

(54) Apparatus and method for crocheting a pre-determined design

(76) Inventor: Hally Lynn Davis, Woodstock, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/211,606

(22) Filed: Aug. 2, 2002

Related U.S. Application Data
(60) Provisional application No. 60/309,994, filed on Aug. 3, 2001.

(51) Int. Cl. G09B 19/20

(52) U.S. Cl. 434/95; 434/81; 434/98

(57) ABSTRACT

An instructional crochet apparatus for crocheting a pre-determined design comprises a grid having a plurality of grid blocks arranged and configured in substantially aligned rows and columns. Each alternating row of the grid is off-set from each other row such that each alternating row is substantially aligned with each other. Color indicators disposed on the grid are arranged and configured to define the pre-determined design. Stitch guides comprise crochet stitch directions. Each grid block substantially corresponds to a crochet stitch and the pre-determined design is created in crochet by crochet stitching performed in accordance with the color indicators and the stitch guides.

### CROSS-REFERENCE TO RELATED APPLICATION

This application claims priority to copending U.S. provisional application entitled, “Apparatus And Method For Crocheting A Pre-Defined Design,” having ser. No. 60/309,994, filed Aug. 3, 2001, which is entirely incorporated herein by reference.

### FIELD OF THE INVENTION

The present invention generally relates to crocheting and, more particularly, to an apparatus and method for crocheting a pre-determined design.

### BACKGROUND OF THE INVENTION

Historically, crochet is a well-known type of needlework in which loops of thread, yarn, cloth, or other weaving materials are interwoven by means of a single hooked needle, or hook. Rows of interlocked looped stitches are connected to form numerous items, such as afghans, articles of clothing, and decorative items, in a variety of textures and styles. In general, patterns for these items are a series of written stitch guides. Often the words and phrases of these written stitch guides are verbose and/or ambiguous, and therefore, complicate the process of crocheting. Due to the complexity of these stitch guides and the manner in which looped stitches interlock, their presentation is often limited to somewhat abstract repetitive patterns rather than a picture or the like.

Thus, a heretofore unaddressed need exists in the industry to address the aforementioned deficiencies and inadequacies.

### SUMMARY OF THE INVENTION

Preferred embodiments of the present invention provide an instructional crochet apparatus for crocheting a pre-determined design. Briefly described, in architecture, one embodiment of the apparatus can be implemented as follows. An instructional crochet apparatus for crocheting a pre-determined design comprises a grid having a plurality of grid blocks arranged and configured in substantially aligned rows and columns. Each alternating row of the grid is off-set from each other row such that each alternating row is substantially aligned with each other. Color indicators disposed on the grid are arranged and configured to define the pre-determined design. Stitch guides comprise crochet stitch directions. Each grid block substantially corresponds to a crochet stitch and the pre-determined design is created in crochet by crochet stitching performed in accordance with the color indicators and the stitch guides.

Preferred embodiment of the present invention can also be viewed as providing methods of method of crocheting a pre-determined design. In this regard, one embodiment of such a method, among other, can be broadly summarized by the following steps: providing a pre-determined design lined with a grid comprising a plurality of grid blocks arranged and configured in substantially aligned rows and columns; shifting each alternating row comprising the grid laterally with respect each other alternating row; providing stitch guides comprising crochet stitch directions; and providing color indicators disposed on the grid, the color indicators comprising the pre-determined design. Each grid block substantially corresponds to a crochet stitch.

Other systems, methods, features, and advantages of the present invention will be or become apparent to one with skill in the art upon examination of the following drawings and detailed description. It is intended that all such additional systems, methods, features, and advantages by included within this description, be with the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a view of an embodiment of at least a portion of an instructional crochet apparatus for crocheting a pre-determined design.

FIG. 2 is a view of a portion of an embodiment of a method for crocheting a pre-determined design.

FIG. 3 is a view of a portion of an embodiment of a method for crocheting a pre-determined design.

### DETAILED DESCRIPTION OF THE PREFERRED EMBODIMENTS

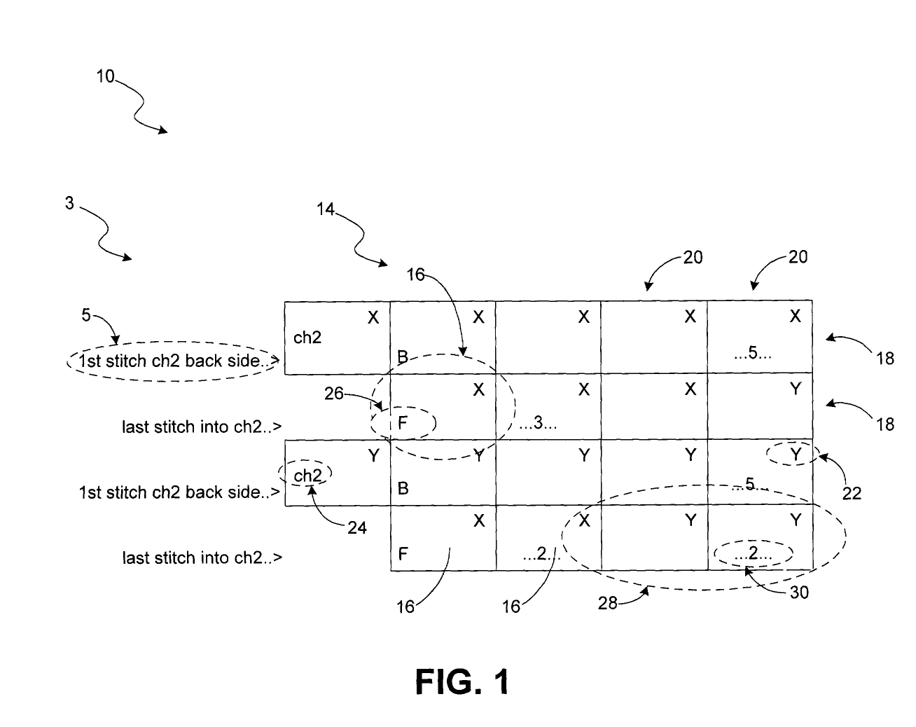

FIG. 1 illustrates one preferred embodiment of an instructional crochet apparatus 10 of the present invention. The instructional crochet apparatus 10 of the present invention is adapted for assisting a user in crocheting a pre-determined design using crochet stitches and knowledge known to one having ordinary skill in the art. Generally, embodiments of the apparatus of the present invention are in the format of a grid, graph, chart, or other instructional symbolic depiction. Embodiments may include instructional stitch indicators such as color, position, numbers representative of amounts of stitches to be performed, thread type, thread size, and hook size. Some embodiments may not include such instructional indicators.

More specifically, reference will now be made in detail to the drawings. As described in greater detail herein, an embodiment of the apparatus 10 of the present to invention is designed to function as a crochet pattern and instructions.

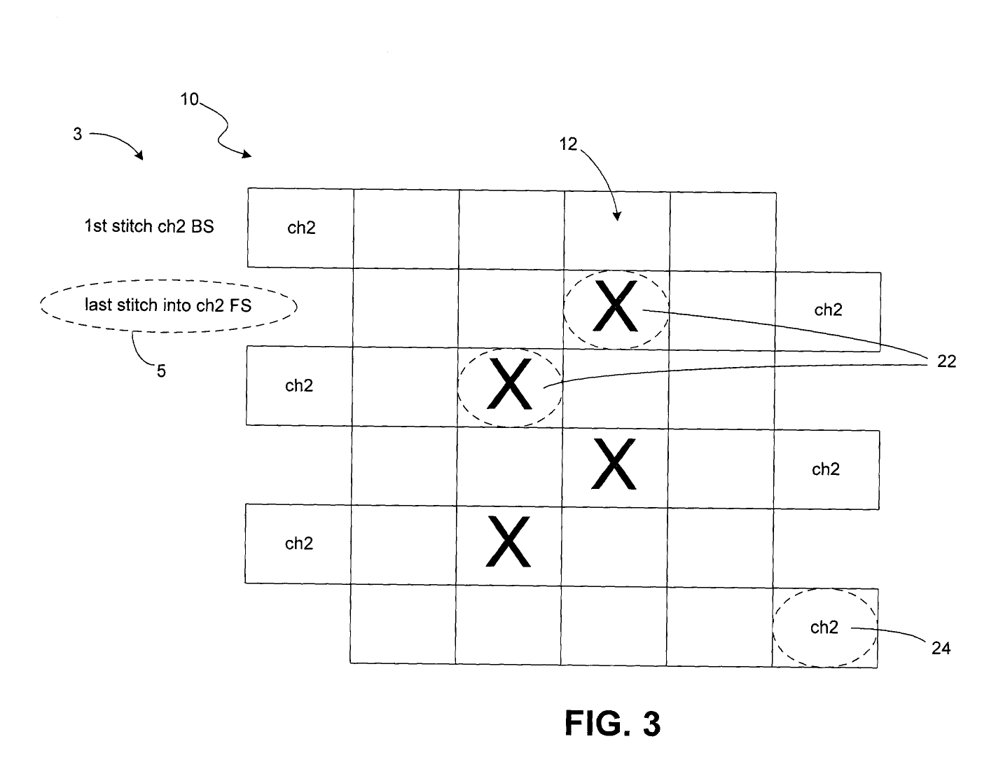

The embodiment shown in FIG. 1 at least a portion of the instructional crochet apparatus 10 includes a grid 14 formed of grid blocks 16. It is preferable that each of the grid blocks 16 have associated with them a color indicator 22. The color indicators 22, when viewed together, create a pre-determined design 12 (FIG. 3). The pre-determined design 12 can comprise any design, scene, picture, wording, etc., desired to be created in a crochet piece. Each of the grid blocks 16 corresponds to a crochet stitch a user creates when crocheting a piece that the user desires to resemble the pre-determined design 12.

It is preferable that each alternate row 18 of the grid 14 is off-set from both the row 18 above and the row 18 below the off-set row 18. The off-set arrangement is most clearly illustrated in FIG. 1 at the left side of the grid 14.

Various types of stitch guides 3 are preferably included with the apparatus 10 in conjunction with the grid 14 in order to aid a user in crocheting the pre-determined design 12. The stitch guides 3 can comprise various types of information, including but not limited to that information contained in the instructions 5, color indicators 22, stitch indicators 24 and position indicators 26. As will be noted by someone skilled in the art, the placement of instructions 5, position indicators 26, stitch indicators 24, color indicators 22, and numbers 30 with respect to the grid 14 can be altered without changing the scope of the invention.

The instructions 5, for example, direct a user in crocheting the beginning or ending of a row 18, which corresponds to an edge of the crochet piece to be created. As an example, one line of instructions 5 in FIG. 1 reads “1st stitch ch2 back side.” This line of instructions 5 tells the user that the first stitch of the row substantially corresponding to the instructions 5 begins with two chain stitches started on the back side of the piece being crocheted. Although the instructions 5 are illustrated as being located on the left side of the grid 14, it should be understood that the instructions 5 can be positioned in any suitable location and in any suitable configuration.

A color indicator 22, as stated previously, is preferably associated with each grid block 16. The color indicator 22 indicates the location of the colors of weaving material recommended to make the pre-determined design 12 (FIG. 3). Although the color indicators 22 are disclosed herein as being disposed within each grid block 16, it should be understood that the color indicators 22 can be disposed in any suitable location. A series of blocks 16 having the same color indicator 22, represented by reference numeral 21, may include a number 30 representative of the quantity of stitches to be performed using that color. The number 30 may be placed anywhere with respect to the series of grid blocks 16. Although the use of a number 30 indicating the quantity of consecutive similarly colored blocks 16 is disclosed herein, should be noted that a number 30 indicating other quantities, such as repeated stitches, or the like, can be used in order to reduce the need for the user to count the blocks 16.

Preferably at least one grid block 16 of each horizontal row 18 of the grid 14 includes a position indicator 26. Position indicator 26 informs a user which side of the piece being crocheted should be in view, or in other words, from which side (i.e. front side or back side) of the piece being crocheted the stitch should be started. Typically, a complete row 18 can be stitched from one same side. However, where the side of the stitch varies, such changes can be indicated by the position indicator 26, as well.

A stitch indicator 24 is located in selected grid blocks 16. The stitch indicator 24 notifies the user when to change the type of stitch the user is performing. The stitch indicator 24 can also indicate to the user what type of stitch should be used.

The instructional crochet apparatus 10 can be combined with at least one crochet needle (not shown) and yam or other crochet material that can be used to create the pre-determined design 12 provided on the apparatus 10. It is preferable that any included yarn or other material be of the recommended colors illustrated on the apparatus 10.

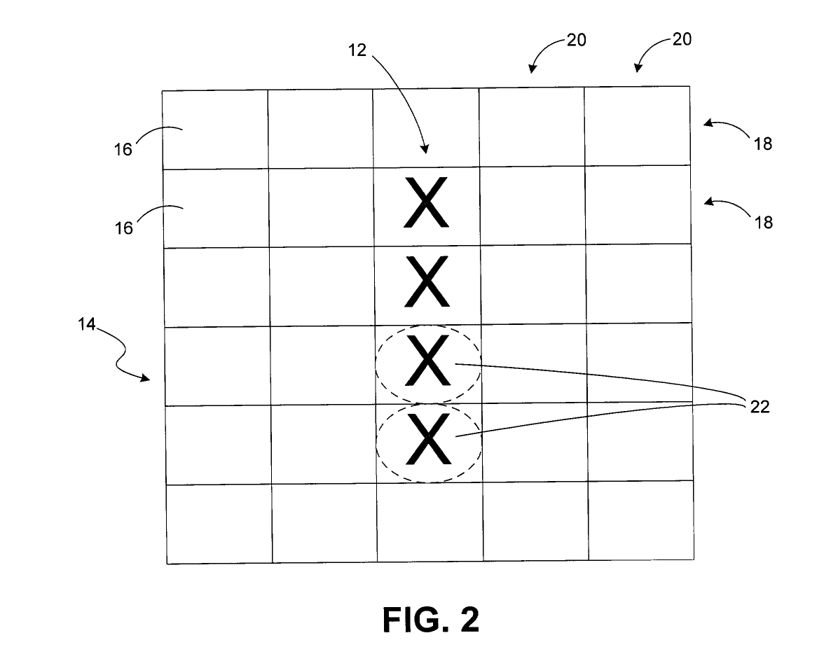

A method for crocheting a pre-determined design is also provided. With reference to FIG. 2, a pre-determined design 12, illustrated herein as a straight line, is provided. A grid 14 is provided overlaying the pre-determined design 12. It is preferable that the pre-determined design is defined by color indicators 22. It should be noted that the color indicators 22 can be disposed in the grid blocks 16 themselves, or can be disposed substantially adjacent the grid blocks 16. The grid 14 comprises rows 18 and columns 20 are arranged in substantial alignment with each other.

Referring next to FIG. 3, alternating rows 18 comprising the grid 14 are shifted along the alternating rows 18. It is preferable that the alternating rows 18 are shifted in substantially the same direction, A, and by the amount of one grid block 16. Upon shifting of the alternating rows 18, the pre-determined design 12 appears distorted as well. This shifting will result in a crochet piece appearing like the pre-determined design 12 before the distortion created by the shift of alternating rows ion direction A. It should be noted that although a straight line is illustrated as the pre-determined design, the design is not limited to such a configuration. The pre-determined design can comprise any scene having various colors, shapes, figures, etc.

As disclosed above, various stitch guides 3 can be provided substantially adjacent to and/or in the grid blocks 16 themselves. With continuing reference to FIG. 3, stitch indicators 24 are disposed in grid blocks 16 over-extending at the edges. Stitch indicators 24 instruct the user of the apparatus 10 what type of crochet stitch or knot to create when creating a stitch that in the actual crochet pattern corresponds to a given grid block 16. In this configuration, the over-extending end grid blocks 16 are noted as being created with two chain stitches (“ch2”). It should be noted that although the over-extending end grid blocks 16 are illustrated as being crocheted with two chain stitches, other crochet stitches are within the spirit of the present invention. It should also be noted that although these stitch indicators 24 are disposed in the grid blocks 16 themselves, the stitch indicators 24 can be disposed in any suitable location.

Another stitch guide 3 that can be provided with the apparatus 10 is a position indicator 26 (FIG. 1). The position indicator 26 directs the user from which side of a piece of crochet work being created the user should make the crochet stitch. This can also generally be thought of as the side of the crochet piece the user should be looking at to start the stitch.

Another stitch guide 3 that can be provided are instructions 5. For example, one of the instructions 3 shown in FIG. 3 states “1st stitch ch2 BS,” directing a user to make two chain stitches starting from the back side (“BS”) of the piece of work being created. It should be noted that this disclosure is not intended to limit the present invention to requiring those particular instructions 5 at that grid block 16. Furthermore, instruction 3 can be expressed in an suitable manner using any suitable expressions, wording, abbreviations, etc. that aid a user in creating the pre-determined design. Numbers 30, as disclosed above, can also be provided in order to easily indicate to the user how many similar stitches are to be performed in a row without requiring the use to count grid blocks 16. In order to create the pre-determined design 12 with crochet stitching, the instructions 5, color indicators 22, position indicators 26 and stitch indicators 24 are followed while performing crochet stitching generally known by one of ordinary skill in the art.

It should be emphasized that the above-described embodiments of the present invention, particularly, and “preferred” embodiments, are merely possible examples of implementation, merely set froth for a clear understanding of the principles of the invention. Many variations and modifications may be made to the above-described embodiment(s) of the invention without departing substantially from the spirit and principles of the invention. All such modifications and variations are intended to be included herein within the scope of the disclosure and the present invention and protected by the following claims.

Therefore, having thus described the invention, at least the following is claimed:

1. An instructional crochet apparatus for crocheting a pre-determined design comprising:
a grid having a plurality of grid blocks arranged and configured in substantially aligned rows and columns, wherein each alternating row of said grid is off-set from each other row such that each alternating row is substantially aligned with each other;
color indicators disposed on said grid, said color indicators being arranged and configured to define the pre-determined design; and
stitch guides comprising crochet stitch directions;
wherein each grid block substantially corresponds to a crochet stitch and said pre-determined design is created in crochet by crochet stitching performed in accordance with said color indicators and said stitch guides.

2. The instructional crochet apparatus for crocheting a pre-determined design of claim 1, wherein said stitch guides comprise:
stitch indicators, said stitch indicators indicating the type of crochet stitch to be used to stitch a particular grid box.

3. The instructional crochet apparatus for crocheting a pre-determined design of claim 1, wherein said stitch guides comprise:
position indicators, said position indicators indicating the direction from which the crochet stitch is created to stitch a particular grid box.

4. The instructional crochet apparatus for crocheting a pre-determined design of claim 1, further comprising:
counters, said counters indicating the number of consecutive grid blocks to be stitched in the same color.

5. The instructional crochet apparatus of claim 1, wherein said pre-determined design comprises a substantially detailed design.

6. A method for crocheting a predetermined design comprising:
providing a pre-determined design lined with a grid comprising a plurality of grid blocks arranged and configured in substantially aligned rows and columns;
shifting each alternating row comprising said grid laterally with respect each other alternating row;
providing stitch guides comprising crochet stitch directions; and
providing color indicators disposed on said grid, said color indicators comprising said pre-determined design;
wherein each grid block substantially corresponds to a crochet stitch.

7. The method of claim 6, wherein said shifting each alternating row further comprises:
shifting each alternating row in a substantially similar direction.

8. The method of claim 6, wherein said shifting each alternating row further comprises:
shifting each alternating row by one grid block with respect to each other alternating row.

9. The method of claim 6, wherein said providing stitch guides further comprises:
providing stitch indicators, said stitch indicators indicating the type of crochet stitch to be used to stitch a particular grid block.

10. The method of claim 6, wherein said providing stitch guides further comprises:
providing position indicators, said position indicators indicating the direction from which the crochet stitch is created to stitch a particular grid block.

11. The method of claim 6, further comprising:
crocheting pursuant to said stitch guides and color indicators.
